(19) United States
(12) Patent Application Publication
(10) Pub. No.: US 2016/0253682 A1
(43) Pub. Date: Sep. 1, 2016

(54) SYSTEMS AND METHODS TO IMPROVE SERVICE MARKET SHARE

(71) Applicant: GM GLOBAL TECHNOLOGY OPERATIONS LLC, Detroit, MI (US)

(72) Inventors: ROBERT R. INMAN, ROCHESTER HILLS, MI (US); MICHAEL S. HARBAUGH, CLARKSTON, MI (US)

(73) Assignee: GM GLOBAL TECHNOLOGY OPERATIONS LLC

(21) Appl. No.: 14/632,232

(22) Filed: Feb. 26, 2015

(51) Int. Cl. G06Q 30/02; G06Q 10/00

(52) U.S. Cl. CPC G06Q 30/0201; G06Q 10/20

(57) ABSTRACT

Systems and methods for calculating service market share, benchmarking service market share, and generating improvement guidance. The systems and methods facilitate analyzing and improving dealer service market share.

### TECHNICAL FIELD

The present disclosure relates generally to improving dealer service market share.

### BACKGROUND

Dealer service includes repair and maintenance performed by dealers such as automotive dealerships. Dealer service market share metrics and benchmarks can be biased and provide unfair measures that are not accepted by a dealer network. For example, such metrics can make good performers look bad and poor performers appear good. In addition, very little actionable information is provided to dealers who want to improve.

### SUMMARY

The present technology relates to improving dealer service market share. For example, the present technology prevents dealers from being fooled by randomness, which occurs when they only see their very limited and biased service data.

According to an exemplary embodiment, a method for calculating service market share, benchmarking service market share, and generating improvement guidance is described.

The method facilitates analyzing and improving dealer service market share. Improved dealer service market share increases the revenue and profit from parts, and increases the profitability of the dealer network. Indirectly, increased dealer service market share increases new vehicle sales because there is a positive relationship between dealer service and new sales.

The method provides a more granular measure of service market share and a measure of network efficiency. The method also provides benchmarks to evaluate the measure of service market share and network efficiency. For example, a benchmark is used to compare a dealer to an aggregation of dealers, such as aggregation of dealers that have a similar measure of competition, and thereby identify opportunities for the dealer to improve. The measures also enables a granular corporate view of service demand and competition.

Other aspects of the present invention will be in part apparent and in part pointed out hereinafter.

### DESCRIPTION OF THE DRAWINGS

FIG. 1 illustrates schematically a system including a computing architecture, according to an embodiment of the present disclosure.

FIG. 2 illustrates a method, according to an embodiment of the present disclosure.

FIG. 3 illustrates schematically a first dealer in a first area and a second dealer in a second area.

FIG. 4 is a bar graph illustrating values of a first measure of service market share, for different service types, and for each of an interest dealer and an aggregation of comparison dealers.

FIG. 5 is a bar graph illustrating values of a second measure of service market share, for different service types, and for each of an interest dealer and an aggregation of comparison dealers.

FIG. 6 is a bar graph illustrating values of a third measure of service market share, for different service types, and for each of an interest dealer and an aggregation of comparison dealers.

FIG. 7 is a bar graph illustrating a number of additional repair orders that would be gained if an interest dealer achieves a value of service market share of an aggregation of comparison dealers, for different sales-area categories.

FIG. 8 is a bar graph illustrating a number of additional repair orders that would be gained if an interest dealer achieves a value of service market share of an aggregation of comparison dealers, for different service types.

FIG. 9 is a bar graph illustrating values of network efficiency for each of an interest dealer and an aggregation of comparison dealers, for various service types.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

As required, detailed embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern.

While the present technology is described primarily herein in connection with automobile dealers that service automobiles, the technology is not limited to automobile dealers. The concepts can be used in a wide variety of applications, such as in connection with aircraft, marine craft, farm equipment, construction equipment, major home appliances (e.g., central AC), and other.

The present disclosure describes systems and methods that include an improved metric of service market share and a benchmark by which to evaluate service market share.

As described herein, the term “service market share” refers to a measure (e.g., observed or estimated using a model) of how many of the services within a category are attributed to a dealer. Exemplary categories are based on whether a vehicle (represented, e.g., by a vehicle identification number (VIN)) is associated with an area that is associated with a dealer and whether the dealer sold the vehicle. A vehicle can be associated with an area in various ways including where the vehicle's owner resides in the area or is employed in the area. A dealer can be associated with an area in various ways including where the dealer is located in the area.

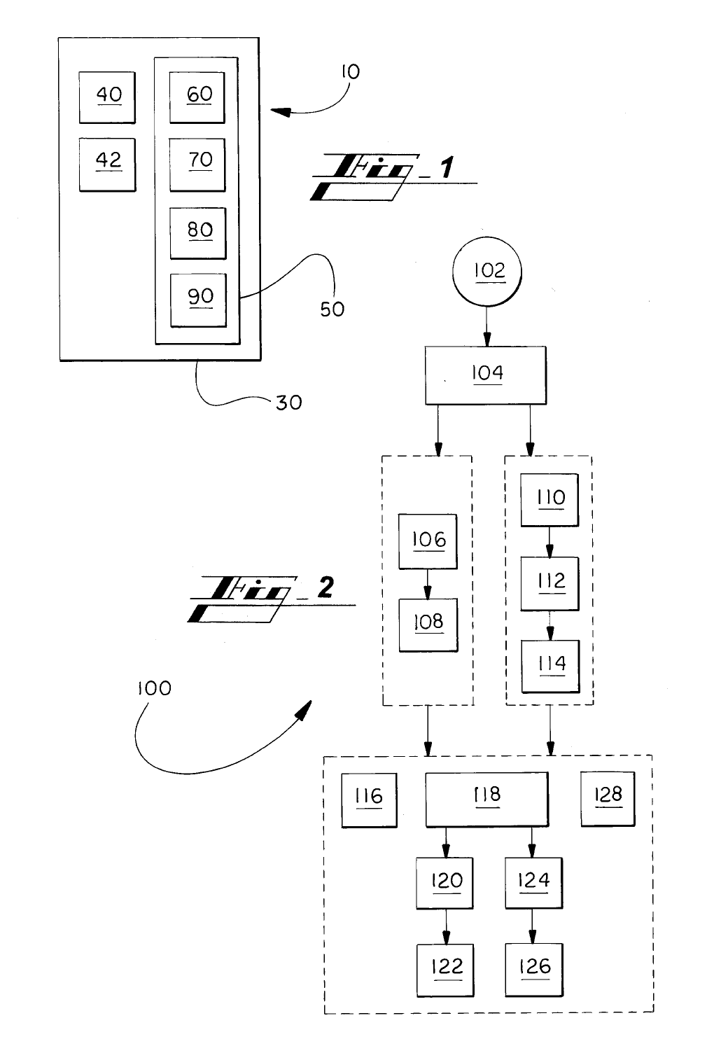

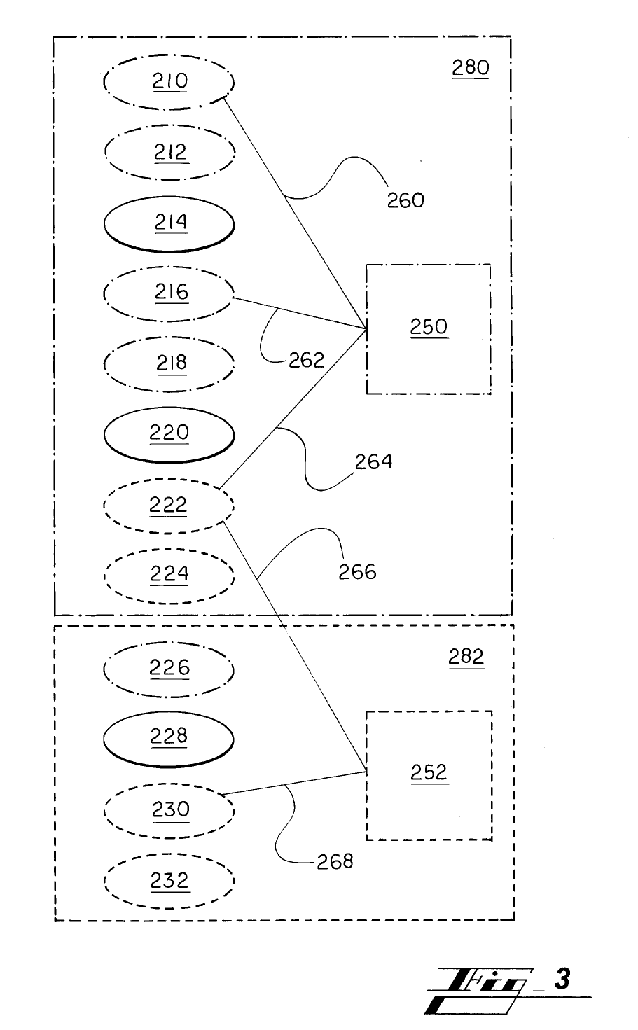

According to one embodiment, a system 10 is configured to perform a method 100. FIG. 1 illustrates schematically features of the system 10. The system 10 includes a computing unit 30. The computing unit 30 includes a processor 40 for controlling and/or processing data, input/output data ports 42, and a memory 50. Connecting infrastructure within the system 10, such as one or more data buses and wireless transceivers, are not shown in detail in order to simplify the figures.

The processor could be multiple processors, which could include distributed processors or parallel processors in a single machine or multiple machines. The processor could include virtual processor(s). The processor could include a state machine, application specific integrated circuit (ASIC), programmable gate array (PGA) including a Field PGA, or state machine. When a processor executes instructions to perform “operations,” this could include the processor performing the operations directly and/or facilitating, directing, or cooperating with another device or component to perform the operations.

The memory 50 can include a variety of computer-readable media, including volatile media, non-volatile media, removable media, and non-removable media. The term “computer-readable media” and variants thereof, as used in the specification and claims, includes storage media. Storage media includes volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or any other medium that is configured to be used to store information that can be accessed by the processor 40.

While the memory 50 is illustrated as residing proximate the processor 40, it should be understood that at least a portion of the memory can be a remotely accessed storage system, for example, a server on a communication network, a remote hard disk drive, a removable storage medium, combinations thereof, and the like. Thus, any of the data, applications, and/or software described below can be stored within the memory and/or accessed via network connections to other data processing systems (not shown) that may include a local area network (LAN), a metropolitan area network (MAN), or a wide area network (WAN), for example.

The memory 50 includes several categories of software and data used in the computing unit 30 including applications 60, a database 70, an operating system 80, and input/output device drivers 90.

The operating system 80 may be any operating system for use with a data processing system. The input/output device drivers 90 may include various routines accessed through the operating system 80 by the applications to communicate with devices, and certain memory components. The applications 60 can be stored in the memory 50 and/or in a firmware (not shown) as executable instructions, and can be executed by the processor 40.

The applications 60 include various programs that, when executed by the processor 40, implement the various features of the computing unit 30. The applications 60 include applications described in further detail with respect to exemplary methods. The applications 60 are stored in the memory 50 and are configured to be executed by the processor 40.

The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

The applications 60 may use data stored in the database 70. The database 70 includes static and/or dynamic data used by the applications 60, the operating system 80, the input/output device drivers 90 and other software programs that may reside in the memory 50.

It should be understood that FIG. 1 and the description above are intended to provide a brief, general description of a suitable environment in which the various aspects of some embodiments of the present disclosure can be implemented. While the description refers to computer-readable instructions, embodiments of the present disclosure also can be implemented in combination with other program modules and/or as a combination of hardware and software in addition to, or instead of, computer readable instructions.

FIG. 2 shows an exemplary method 100 that facilitates analyzing and improving service market share, according to an embodiment of the present disclosure. It should be understood that the steps of the method 100 are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims.

It should also be understood that the illustrated method 100 can be ended at any time. In certain embodiments, some or all steps of this process, and/or substantially equivalent steps are performed by execution of computer-readable instructions stored or included on a computer readable medium, such as the memory 50 of the computing unit 30 described above, for example.

The method 100 begins 102 and flow proceeds to blocks 104, 106, 108, 110, 112, 114, 116, 118, 120, 122, 124, 126. Block 104 is associated with computer executable instructions for accessing and sorting dealer service data; blocks 106, 108, 110, 112, 114 are associated with computer executable instructions for generating values of dealer service market share, group service market share, and network efficiency; and blocks 116, 118, 120, 122, 124, 126 are associated with computer executable instructions for generating an objects to provide feedback and guidance, for example, to an interest dealer.

In block 104, the processor 40 accesses dealer service data 200 stored in the memory 50. The dealer service data 200 includes data that represents vehicles (e.g., same-brand vehicles, units in operation (UIO)), the dealer (or dealers) that have serviced the vehicle, the location of the customer who owns the vehicle, and the service type. The dealer service data 200 for a dealer is sorted or filtered into different categories or sets.

The dealer service data 200 is sorted by service type (e.g., repair type). Service types include lube-oil-filter (LOF), brakes, tires, suspension, batteries, filters, wipers, belts and hoses, AC/Cooling, transmission, engine, ignition, emissions, electronic control modules (ECM), electrical/wiring, steering, fuel system, drive train, chassis, starter/alternator, heating, exhaust, body, lighting, accessories, wheels, and the like.

The dealer service data 200 is then further sorted into categories based on sales and geography. For example, for each service type, one or more cells of Table 1 represent a category based on sales and geography, as described in further detail below. The variables a, b, c, d and A, B, C, D in Table 1 represent a number of services in a category for a first dealer and a first service type, as described in further detail below. In general, a set of vehicles is generated for each dealer, category, and service type.

TABLE 1

| | Sold | Not Sold |
|---|---|---|
| In Area | a | b |
| | A | B |
| Out of Area | c | d |
| | C | D |

In Table 1, variables a, b, c, d are numbers of a first service type.

Variable a is the number of the first service type by the first dealer for vehicles that were sold by the first dealer to customers residing in the first dealer's area (e.g., a repair order (RO) includes the first service type); variable b is the number of the first service type by the first dealer for vehicles that were sold by another dealer (e.g., a second dealer) to customers residing in the first dealer's area; variable c is the number of the first service type by the first dealer for vehicles that were sold by the first dealer to customers residing out of the first dealer's area (e.g., in a second dealer's area); and variable d is the number of the first service type by the first dealer for vehicles that were sold by another dealer (e.g., a third dealer) to customers residing out of the first dealer's area.

In certain embodiments, a service by a dealer is included in the number of services by the dealer only if the service is performed within a certain time window. For example, the time window is within one year since sale, two to six years since sale, or more than six years since sale. In certain embodiments, a service by a dealer is included in the number of services based on if the service is performed on a vehicle that was bought in new condition and still owned or based on if the service is performed on a vehicle that was bought in used condition.

In Table 1, variables A, B, C, D are the numbers of vehicles that are eligible for a service type in a category. An eligible vehicle is a unit in operation for which a service is possible. Here, the number of eligible vehicles represents the estimated number of services that can be performed. Whether a vehicle is an eligible vehicle can be based on model and age or otherwise using failure rate data.

Variable A is the number of eligible vehicles that were sold by the first dealer to customers residing in the first dealer's area; variable B the number of eligible vehicles that were sold by another dealer (e.g., a second dealer) to customers residing in the first dealer's area; variable C is the number of eligible vehicles that were sold by the first dealer to customers residing out of the first dealer's area; and variable D is the number of eligible vehicles that were sold by another dealer (e.g., a second dealer) to customers residing out of the first dealer's area.

The cells of Table 1 represent two relationships between a dealer and a customer: a sales-based relationship and a geography-based relationship. By sorting the dealer service data 200 into categories, a finer, more granular measure of service market share (r) can be determined for each service type.

Blocks 106, 108 are associated with computer executable instructions for generating values of dealer service market share and network efficiency.

In block 106, the processor 40 calculates values of dealer service market share rₖ using the sorted dealer service data 200. For example, values of dealer service market share r₁, r₂, r₃, r₄ are calculated for a first service type s using values for the variables of Table 1 as follows:

$${r}_{1} = \frac{a}{A}$$

$${r}_{2} = \frac{b}{B}$$

$${r}_{3} = \frac{c}{C}$$

$${r}_{4} = \frac{d}{D}$$

In block 108, in addition to dealer service market share r₁, r₂, r₃, r₄, a network efficiency NE is calculated based on dealer service market shares r₁, r₂, r₃. Further described, the network efficiency NE is a metric that reflects dealer service market share among the sales-geography categories of sold-in-market (r₁), not-sold-in-market (r₂), and sold-not-in-market (r₃).

Network efficiency NE for a dealer is calculated based on the sold-in-market dealer service market share r₁, the not-sold-in-market dealer service market share r₂, and the sold-out-of-market dealer service market share r₃. For example, a network efficiency loss NE_{L} is calculated as:

NE_{L}=r₁−r₂−r₃.

Network efficiency NE is then calculated as:

NE=1−NE_{L}

Blocks 110, 112, 114 are associated with computer executable instructions for generating values of group service market share and network efficiency.

Dealer service market share r₁, r₂, r₃ and network efficiency NE are calculated for individual dealers and for aggregations of dealers. Dealers j are aggregated, for example, by district, zone, state, region, national boundary, or a non-geographic characteristic such as brand or business size. Dealers j are also aggregated by creating sets of dealers that face similar levels of competition, as described in further detail below.

One measure of competition is service density, which can be based, for example, on a number of service providers of service type s and a number of eligible vehicles. A service provider is a facility that offers the same service type s as the interest dealer. These may be dealers of different brands, or independent service providers. These other service providers compete with the interest dealer to provide service type s to customers who reside in the interest dealer's geography.

According to the block 110, for each dealer, a service density is calculated for each service type s. The service density is calculated as the number of vehicles that are eligible for service and associated with the dealer's geography divided by a number of service type s providers competing for service type s in the dealer's geography.

Each of a number of comparison sets then includes dealers who have the same or similar service density (e.g., within a certain range of values). Here, similar service density represents similar degrees of competition for a service type s.

According to the block 112, group service market share r^{g}₁, r^{g}₂, r^{g}₃, r^{g}₄ for an aggregation of dealers are generated and displayed. The numbers for variables a, b, c, d, A, B, C, D of Table 1 are accessed for each dealer j in an aggregation of dealers and are then combined. For example, group service market share is calculated as:

$${r}_{1}^{g} = \frac{{Σ}_{j} {a}_{j}}{{Σ}_{j} {A}_{j}}$$

$${r}_{2}^{g} = \frac{{Σ}_{j} {b}_{j}}{{Σ}_{j} {B}_{j}}$$

$${r}_{3}^{g} = \frac{{Σ}_{j} {c}_{j}}{{Σ}_{j} {C}_{j}}$$

$${r}_{4}^{g} = \frac{{Σ}_{j} {d}_{j}}{{Σ}_{j} {D}_{j}}$$

According to the block 114, once the group service market share r^{g}₁, r^{g}₂, r^{g}₃ for an aggregation of dealers is determined, the network efficiency NE^{g} is calculated for the aggregation of dealers. Network efficiency NE^{g} for an aggregation of dealers is calculated based on the sold-in-market group service market share r^{g}₁, the not-sold-in-market group service market share r^{g}₂, and the sold-out-of-market group service market share r^{g}₃. For example, a network efficiency loss NE^{g}_{L} is calculated as:

NE^{g}_{L}=r^{g}₁−r^{g}₂−r^{g}₃

Network efficiency NE^{g} is then calculated as:

NE^{g}=1−NE^{g}_{L}

Blocks 116, 118, 120, 122, 124, 126 are associated with computer executable instructions for generating objects to provide feedback and guidance to dealers or others based on the dealer service market share, dealer network efficiency, the group service market share, and the group network efficiency. Exemplary objects, including tables and bar charts, are now described in further detail.

At the block 116, the processor generates a table comparing an interest dealer to different aggregations of comparison dealers. The different aggregations of comparison dealers may or may not include the interest dealer. The interest dealer can alternatively or additionally be compared to a comparison dealer.

Similarly, instead or in addition to the interest dealer, the processor generates a table comparing an aggregation of interest dealers to different aggregations of comparison dealers. The different aggregations of comparison dealers may or may not include the aggregations of interest dealers.

Referring to Table 2, for a service type s, exemplary values of group service market share r^{g}₁, r^{g}₂, r^{g}₃ and values for network efficiency NE^{g} are shown for different aggregations of dealers. Here, the aggregations of dealers are a district, a zone, a state, a region, a nation, and a competitive set.

The values are indexed to benchmarked values of service market share and values of network efficiency NE, respectively. For example, where the value meets the benchmarked value, the percentage is 100%; where the value is below the benchmarked value, the percentage is below 100%; and where the value is above the benchmarked value, the percentage is above 100%. The table allows one to analyze aggregations of dealers to evaluate whether the aggregations of dealers have good or poor network optimization.

TABLE 2

| | r^{g}₁ | r^{g}₂ | r^{g}₃ | NE^{g} |
|---|---|---|---|---|
| District | 95% | 94% | 102% | 88% |
| Zone | 94% | 95% | 103% | 91% |
| State | 96% | 101% | 104% | 90% |
| Region | 97% | 100% | 101% | 91% |
| National | 94% | 89% | 102% | 98% |
| Competition Set | 109% | 102% | 121% | 107% |

Similarly, for a service type s, exemplary values of group service market share r^{g}₁, r^{g}₂, r^{g}₃ and values for network efficiency NE^{g} can be generated for a different aggregation of dealers. For example, the different aggregation of dealers is an aggregation of interest dealers associated with a district in a zone, a state, a region, a nation, and a competitive set. Here, the values associated with the aggregation of comparison dealers are indexed to the values associated with the aggregation of interest dealers. For example, the values associated with the aggregation of comparison dealers are indexed to values of group service market share r^{g}₁, r^{g}₂, r^{g}₃ and the value of network efficiency NE^{g} of the aggregation of interest dealers.

At the block 116, the processor generates bar graphs comparing an interest dealer (or an aggregation of interest dealers) to an aggregation of comparison dealers (or a single comparison dealer).

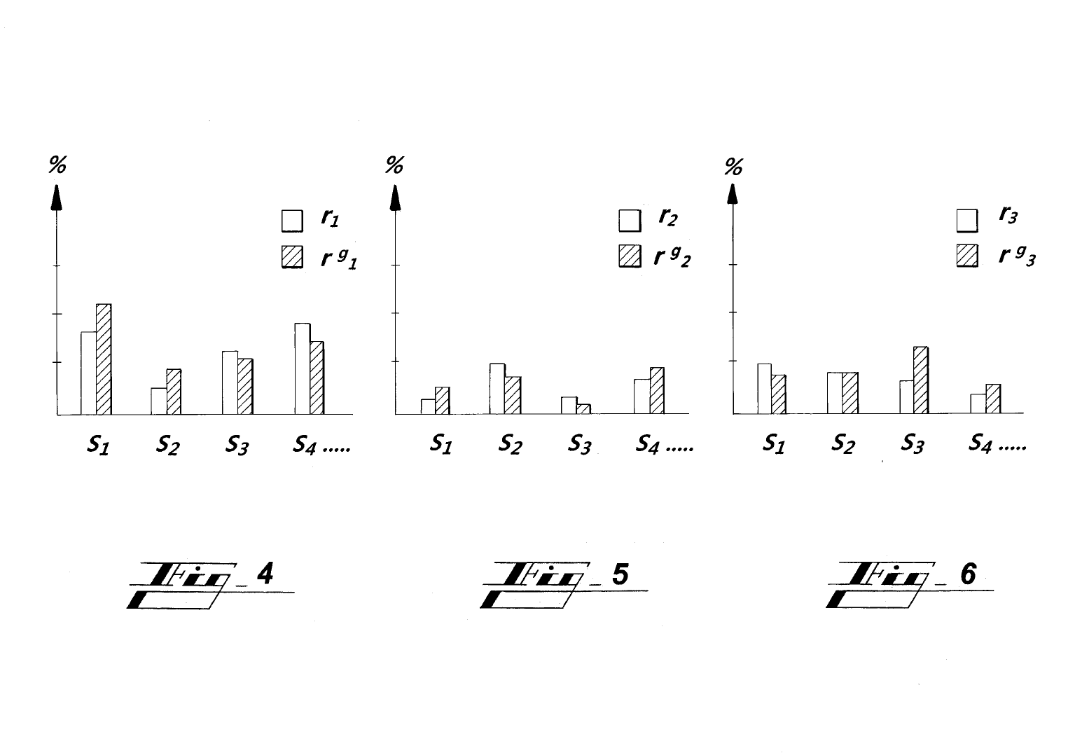

Particularly, at the block 116, referring to FIGS. 4-6, for various service types s, values of service market share are displayed for an interest dealer (r₁, r₂, r₃) and for an aggregation of comparison dealers (r^{g}₁, r^{g}₂, r^{g}₃). The values of group service market share r^{g}₁, r^{g}₂, r^{g}₃ provide a benchmark by which the dealer service market share r₁, r₂, r₃ can be evaluated for each service type s.

The aggregation of comparison dealers may or may not include the interest dealer, for example, for purposes of calculation.

In certain embodiments, alternatively or additionally, service market share for a comparison dealer is displayed.

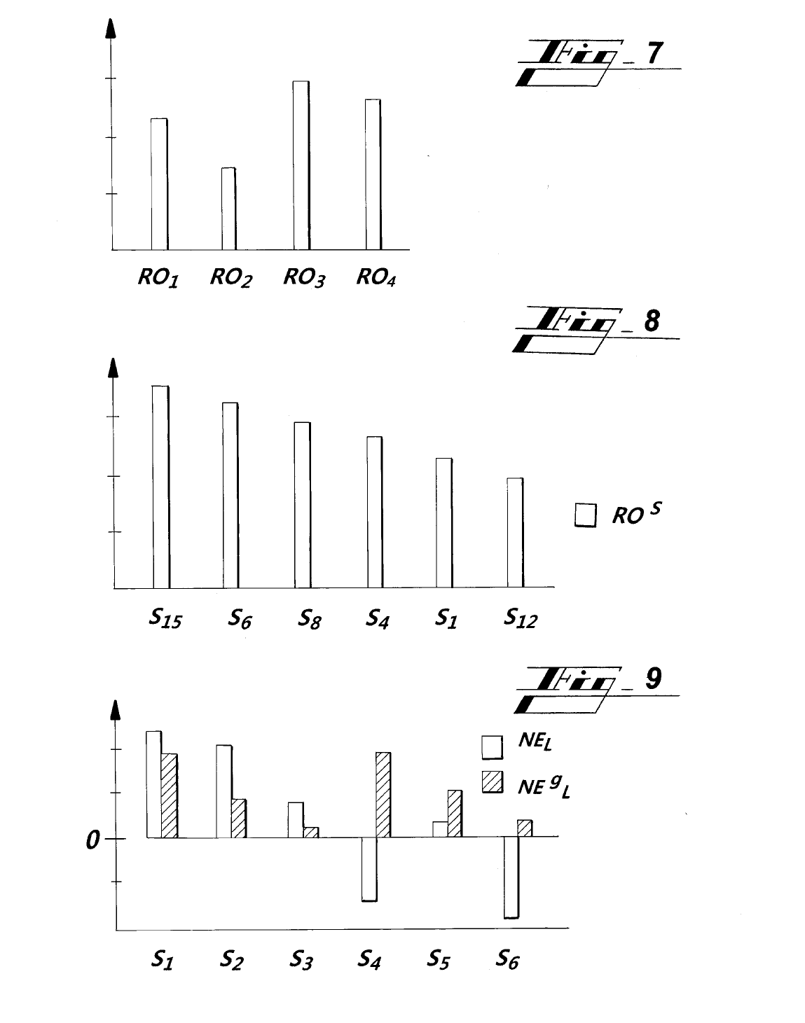

At the block 118, referring to FIGS. 7 and 8, for each service type s, values of group service market share r^{g}₁, r^{g}₂, r^{g}₃, r^{g}₄ of an aggregation of comparison dealers are used to calculate the number of additional repair orders (RO) that would be gained if the interest dealer achieves the group service market share r^{g}₁, r^{g}₂, r^{g}₃, r^{g}₄ of the aggregation of comparison dealers. The interest dealer may or may not be one of the aggregation of comparison dealers.

For a service type s, the number of additional repair orders (RO) that would be gained in each sales-geography category if the interest dealer achieves the service market share of the aggregation of comparison dealers is calculated by:

RO₁=(r^{g}₁*A−a)

RO₂=(r^{g}₂*B−b)

RO₃=(r^{g}₃*C−c)

RO₄=(r^{g}₄*D−d)

In certain embodiments, additionally or alternatively, values of service market share of a comparison dealer is used to calculate the number of additional repair orders (RO) that would be gained if the interest dealer achieves the service market share of the comparison dealer.

At the blocks 120, 122, referring to FIG. 7, the additional repair orders RO are generated and displayed for each sales-geography category. At the block 120, for each sales-geography category, the additional repair orders RO₁, RO₂, RO₃, RO₄ are aggregated for all service types s. At the block 122, for each sales-area category, the bar graph displays the number of additional repair orders RO that would be gained if the dealer achieves the group service market share r^{g}₁, r^{g}₂, r^{g}₃, r^{g}₄ in that sales-area category.

At the blocks 124, 126, the additional repair orders RO are generated and displayed for each service type s. At the block 124, the sales-area categories are aggregated for each service type s. For example, for each service type s, the number of additional repair orders RO that would be gained in all categories if the interest dealer achieves the service market share of the aggregation of comparison dealers is calculated by:

RO^{s}=RO₁+RO₂+RO₃+RO₄

At the block 126, referring to FIG. 8, the number of additional repair orders RO^{s} are displayed by service type s. The additional repair orders RO^{s} are arranged in descending order, beginning with the service type s where the most additional repair orders RO^{s} would be gained if the interest dealer achieves the group service market share r^{g}₁, r^{g}₂, r^{g}₃, r^{g}₄ of the aggregation of comparison dealers. The bar graph of FIG. 8 provides feedback, for example, by highlighting which of the service types s provide the most opportunity for improvement.

Alternatively, instead of prioritizing based on an increase in numbers of repair orders RO, the increase in numbers of repair orders RO can be converted to increase in profit (or revenue), and the profits are arranged in descending order, beginning with the service type s where the most profit would be gained if the dealer achieves the group service market share r^{g}₁, r^{g}₂, r^{g}₃, r^{g}₄ of the aggregation of dealers. For example, for a service type s, additional profit is equal to the number of repair orders RO multiplied by the average profit (or revenue) per the service type.

At a block 128, referring to FIG. 9, values of network efficiency loss NE_{L}, NE^{g}_{L} are generated and displayed for an interest dealer and an aggregation of comparison dealers (here, a district and a nation). The values of network efficiency loss NE^{g}_{L} of an aggregation of comparison dealers provide a benchmark by which the interest dealer can be evaluated and variances in performance can be used to identify best practices.

Referring to FIG. 9, for various service types s, values of network efficiency are shown for an interest dealer (r₁, r₂, r₃) and for an aggregation of comparison dealers (r^{g}₁, r^{g}₂, r^{g}₃) (here, the aggregation of comparison dealers is a competition set). The values of group service market share r^{g}₁, r^{g}₂, r^{g}₃ provide a benchmark by which the dealer service market share r₁, r₂, r₃ can be evaluated for each service s.

In certain embodiments, the network efficiency loss of different mutually exclusive aggregations of dealers (e.g., an aggregation of interest dealers and an aggregation of comparison dealers), such as all the districts in a larger region, are compared. This provides a performance appraisal of different districts and enables identifying best practices.

Various embodiments of the present disclosure are disclosed herein. The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A method, comprising:
calculating, by a system comprising a processor, for each of a plurality of service types; and for each of at least one interest dealer and at least one comparison dealer:
a first dealer market share value that is calculated based on a first number of dealer services divided by a first number of total services, wherein:
the first number of dealer services includes services of the service type that were performed on vehicles that are associated with a dealer-area and that were sold by the dealer; and
the first number of total services includes services of the service type and is determined based on vehicles that are associated with the dealer-area and that were sold by the dealer;
a second dealer market share value that is calculated based on a second number of dealer services divided by a second number of total services, wherein:
the second number of dealer services includes services of the service type that were performed on vehicles that are associated with the dealer-area and that were not sold by the dealer; and
the second number of total services includes services of the service type and is determined based on vehicles that are associated with the dealer-area and that were not sold by the dealer; and
a third dealer market share value that is calculated based on a third number of dealer services divided by a third number of total services, wherein:
the third number of dealer services includes services of the service type that were performed on vehicles that are not associated with the dealer-area and that were sold by the dealer; and
the third number of total services includes services of the service type and is determined based on vehicles that are not associated with the dealer-area and that were sold by the dealer; and
generating at least one object that is a visual representation that is based on at least one of the first dealer market share, the second dealer market share, and the third dealer market share of each of the at least one interest dealer and the at least one comparison dealer.

2. The method of claim 1, wherein the object compares the at least one of the first dealer market share, the second dealer market share, and the third dealer market share of the at least one interest dealer to the respective at least one of the first dealer market share, the second dealer market share, and the third dealer market share of the at least one comparison dealer.

3. The method of claim 1, wherein the object compares at least one of the first dealer market share of the interest dealer, the second dealer market share of the interest dealer, and the third dealer market share of the at least one interest dealer to a respective one of the first dealer market share of the interest dealer, the second dealer market share of the interest dealer, and the third dealer market share of the at least one interest dealer of the at least one comparison dealer.

4. The method of claim 1, further comprising calculating, by the system, for each of a plurality of service types, and for each of at least one interest dealer and at least one comparison dealer, a dealer network efficiency based on the first dealer market share minus the second dealer market share and minus the third dealer market share.

5. The method of claim 1, further comprising calculating, by the system, for each of the plurality of service types and for at least one of an aggregation of interest dealers and an aggregation of comparison dealers, wherein the aggregation of interest dealer includes the at least one interest dealer and the aggregation of comparison dealers includes the at least one comparison dealer:
a first group market share value that is calculated based on a first dealer sum divided by a first total sum, wherein:
the first dealer sum includes a sum of the first number of dealer services of each of the aggregation of dealers; and
the first total sum includes a sum of the first number of total services of each of the aggregation of dealers;
a second group market share value that is calculated based on a second dealer sum divided by a second total sum, wherein:
the second dealer sum includes a sum of the second number of dealer services of each of the aggregation of dealers; and
the second total sum includes a sum of the second number of total services of each of the aggregation of dealers; and
a third group market share value that is calculated based on a third dealer sum divided by a third total sum, wherein:
the third dealer sum includes a sum of the third number of dealer services of each of the aggregation of dealers; and
the third total sum includes a sum of the third number of total services of each of the aggregation of dealers; and
generating an object that is a visual representation that is based on at least one of the first group market share, the second group market share, and the third group market share of at least one of the aggregation of interest dealers and the aggregation of comparison dealers.

6. The method of claim 5, wherein the object compares the at least one of the first group market share, the second group market share, and the third group market share of the aggregation of interest dealers to the respective at least one of the first group market share, the second group market share, and the third group market share of the aggregation of comparison dealers.

7. The method of claim 5, further comprising:
calculating a competition parameter value for each of a plurality of dealers; and
identifying the dealers of the aggregation of comparison dealers from the plurality of dealers based on the calculated competition parameter values.

8. The method of claim 7, wherein the competition parameter value is a service density value, wherein the service density value is calculated as a number of vehicles that are eligible for a service in the dealer-area divided by a number of service providers competing for the service in the dealer-area.

9. The method of claim 7, wherein dealers for which the competition parameter value is within a predetermined range of values are identified as the dealers of the aggregation of comparison dealers.

10. The method of claim 5, wherein at least one of aggregation of interest dealers and the aggregation of comparison dealers is associated with one of a district, a zone, a state, a region, and a national boundary.

11. The method of claim 5, wherein the object compares at least one of the first dealer market share of the interest dealer, the second dealer market share of the interest dealer, and the third dealer market share of the at least one interest dealer to a respective one of the first group market share, the second group market share, and the third group market share of the aggregation of comparison dealers.

12. The method of claim 5, wherein the object compares at least one of the first group market share of the interest dealer, the second group market share of the interest dealer, and the third group market share of the aggregation of interest dealers to a respective one of the first group market share, the second group market share, and the third group market share of the aggregation of comparison dealers.

13. The method of claim 5, comprising:
calculating, by the, for each of the plurality of service types; for each of the at least one interest dealer and the at least one comparison dealer:
a fourth dealer market share value that is based on a fourth number of dealer services divided by a fourth number of total services, wherein:
the fourth number of dealer services includes services of the service type that were performed on vehicles that are not associated with the dealer-area and that were not sold by the dealer; and
the fourth number of total services includes services of the service type and is determined based on vehicles that are not associated with the dealer-area and that were not sold by the dealer; and
calculating, by the system, for each of the plurality of service types and for the at least one of the aggregation of interest dealers and the aggregation of comparison dealers:
a fourth group market share value based on a fourth dealer sum divided by a fourth total sum, wherein:
the fourth dealer sum includes a sum of the fourth number of dealer services of each of the aggregation of dealers; and
the fourth total sum includes a sum of the fourth number of total services of each of the aggregation of dealers.

14. The method of claim 13, further comprising:
calculating, for each of the plurality of service types, a number of repair orders based on one or more of:
the first number of total services of one of the at least one interest dealer and one of:
the first dealer market share of one of the at least one comparison dealer; and
the first group market share of the aggregation of comparison dealers;
the second number of total services of the one of the at least one interest dealer and one of:
the second dealer market share of the one of the at least one comparison dealer; and
the second group market share of the aggregation of comparison dealers;
the third number of total services of the one of the at least one interest dealer and one of:
the third dealer market share of the one of the at least one comparison dealer; and
the third group market share of the aggregation of comparison dealers; and
the fourth number of total services of the one of the at least one interest dealer and one of:
the fourth dealer market share of the one of the at least one comparison dealer; and
the fourth group market share of the aggregation of comparison dealers;
calculating an aggregated number of repair orders as a sum of the numbers of repair orders for all of the plurality of service types; and
generating an object displaying the aggregated number of repair orders.

15. The method of claim 13, further comprising:
calculating, for each of the plurality of service types:
a first number of repair orders based on the first number of total services of one of the at least one interest dealer and one of:
the first dealer market share of one of the at least one comparison dealer; and
the first group market share of the aggregation of comparison dealers;
a second number of repair orders based on the second number of total services of the one of the at least one interest dealer and one of:
the second dealer market share of the one of the at least one comparison dealer; and
the second group market share of the aggregation of comparison dealers;
a third number of repair orders based on the third number of total services of the one of the at least one interest dealer and one of:
the third dealer market share of the one of the at least one comparison dealer; and
the third group market share of the aggregation of comparison dealers; and
a fourth number of repair orders based the fourth number of total services of the one of the at least one interest dealer and one of:
the fourth dealer market share of the one of the at least one comparison dealer; and
the fourth group market share of the aggregation of comparison dealers; and
calculating, for each of the plurality of service types, an aggregated number of repair orders as a sum of the first number of repair orders, the second number of repair orders, the third number of repair orders, and the fourth number of repair orders; and
generating an object displaying the aggregated numbers of repair orders for each of the plurality of service types.

16. The method of claim 15, further comprising ordering the plurality of service types according the aggregated numbers of repair orders.

17. The method of claim 5, further comprising calculating, by the system, for each of the plurality of service types and for at least one of the aggregation of interest dealers and the aggregation of comparison dealers, a group network efficiency that is based on the first group market share minus the second group market share and minus the third group market share.

18. A system, comprising:
a processor;
a memory comprising instructions that, when executed by the processor, cause the processor to perform operations comprising:
calculating, for each of a plurality of service types; and for each of at least one interest dealer and at least one comparison dealer:
a first dealer market share value that is calculated based on a first number of dealer services divided by a first number of total services, wherein:
the first number of dealer services includes services of the service type that were performed on vehicles that are associated with a dealer-area and that were sold by the dealer; and
the first number of total services includes services of the service type and is determined based on vehicles that are associated with the dealer-area and that were sold by the dealer;
a second dealer market share value that is calculated based on a second number of dealer services divided by a second number of total services, wherein:
the second number of dealer services includes services of the service type that were performed on vehicles that are associated with the dealer-area and that were not sold by the dealer; and
the second number of total services includes services of the service type and is determined based on vehicles that are associated with the dealer-area and that were not sold by the dealer; and
a third dealer market share value that is calculated based on a third number of dealer services divided by a third number of total services, wherein:
the third number of dealer services includes services of the service type that were performed on vehicles that are not associated with the dealer-area and that were sold by the dealer; and
the third number of total services includes services of the service type and is determined based on vehicles that are not associated with the dealer-area and that were sold by the dealer; and
generating at least one object that is a visual representation that is based on at least one of the first dealer market share, the second dealer market share, and the third dealer market share of each of the at least one interest dealer and the at least one comparison dealer.

19. The system of claim 18, wherein the object compares the at least one of the first dealer market share, the second dealer market share, and the third dealer market share of the at least one interest dealer to the respective at least one of the first dealer market share, the second dealer market share, and the third dealer market share of the at least one comparison dealer.

20. A computer-readable medium comprising instructions that, when executed by a processor, cause the processor to perform operations comprising:
calculating, for each of a plurality of service types; and for each of at least one interest dealer and at least one comparison dealer:
a first dealer market share value that is calculated based on a first number of dealer services divided by a first number of total services, wherein:
the first number of dealer services includes services of the service type that were performed on vehicles that are associated with a dealer-area and that were sold by the dealer; and
the first number of total services includes services of the service type and is determined based on vehicles that are associated with the dealer-area and that were sold by the dealer;
a second dealer market share value that is calculated based on a second number of dealer services divided by a second number of total services, wherein:
the second number of dealer services includes services of the service type that were performed on vehicles that are associated with the dealer-area and that were not sold by the dealer; and
the second number of total services includes services of the service type and is determined based on vehicles that are associated with the dealer-area and that were not sold by the dealer; and
a third dealer market share value that is calculated based on a third number of dealer services divided by a third number of total services, wherein:
the third number of dealer services includes services of the service type that were performed on vehicles that are not associated with the dealer-area and that were sold by the dealer; and
the third number of total services includes services of the service type and is determined based on vehicles that are not associated with the dealer-area and that were sold by the dealer; and
generating at least one object that is a visual representation that is based on at least one of the first dealer market share, the second dealer market share, and the third dealer market share of each of the at least one interest dealer and the at least one comparison dealer.
